(19) United States
(12) Patent Application Publication
(10) Pub. No.: US 2012/0209751 A1
(43) Pub. Date: Aug. 16, 2012

(54) SYSTEMS AND METHODS OF GENERATING USE-BASED PRODUCT SEARCHING

(75) Inventors: Francine Chen, Menlo Park, CA (US); Scott Carter, Los Altos, CA (US); Aditi Shrikumar, Fremont, CA (US); Jeremy Pickens, Bloomville, NY (US)

(73) Assignee: FUJI XEROX CO., LTD., Tokyo (JP)

(21) Appl. No.: 13/025,960

(22) Filed: Feb. 11, 2011

(51) Int. Cl. G06Q 30/00

(52) U.S. Cl. 705/27.2

(57) ABSTRACT

Systems and methods are directed to use-based product searching. Raw product information data, such as product features, specifications, and user reviews are processed and analyzed using pattern-based text analysis to extract relevant product aspects and uses. The aspects are weighted in relation to their importance for various uses, and the corresponding aspects and their weights are linked to the uses. A user selects uses for a product, which correspond to weighted aspects, and the weights for the aspects are used to rank products using the weights of the aspects linked to the selected uses. The ranked products are presented to the user in a customizable interface. The user may directly specify weights for the extracted aspects to further customize the ranked list of products. The interface provides additional options for viewing product details, opinions and comparisons.

### BACKGROUND

1. Field of the Invention

This invention relates to systems and methods for use-based product searching, and more particularly to a user interface providing use-based product information based on aspects and uses extracted from raw product data.

2. Description of the Related Art

While there are many commercial systems designed to help users browse, search, and compare products, these interfaces are typically product centric—permitting users to, browse product information. There is an ever-increasing amount of official and user-generated product information on the Internet that users use to make purchasing decisions. The official product information may include a product manufacturer or seller's information on the features, specifications, settings and prices of a product. The user-generated product information may include user reviews, including further information about the product or opinions of the product in terms of its functionality, usefulness and relevance to a particular use for which a user purchased the product. The users will often provide ratings of particular features of the product in addition to a rating of the product in general, which allows a potential buyer to determine how current users rate the important features of a product.

Sifting through the vast amount of official and user-generated product information can be tedious, overwhelming and time-consuming. A user may have difficulty finding a user review relevant to a particular feature of interest. When reviewing information on products such as consumer electronics, the user may not have the technical knowledge to understand the features of a product, and may instead look to the user reviews for information on whether the product is adequate for a particular use that the user is interested in.

For example, the user may be interested in a camera for taking camping or hiking, and may therefore want a durable camera that takes good pictures outdoors. However, this type of high-level product information—a particular use during which the user wishes to use the camera—is not usually available, as most product information is related to low-level features such as a camera's zoom, storage capacity, mega pixel rating or battery life. While a user may have discussed the product in terms of this use in a user review, the user would need to sort through the dozens of reviews in order to find out whether a user had reviewed the product for that particular use.

As a result of the above limitations, websites with user-generated reviews and low-level product information are often inadequate in helping a user determine whether to purchase a particular product.

### SUMMARY

Systems and methods described herein provide use-based product searching by analyzing raw product information to provide a customizable user interface focused on high-level product information tailored to a user's needs. All types of product information, from product specifications, attributes, and user reviews, are mined in order to determine product aspects and uses relevant to the user. Product aspects may be product features, specifications and attributes. The user is provided with a graphical user interface (GUI) with which to select the uses for which they plan to use the product, as well as areas to adjust the weight, or importance, of aspects related to those uses. For each use, a weight is associated with each product aspect in relation to the importance of that aspect for the use, and these weights are then used to rank the products using the weights of the aspects linked to the selected uses. The user interface then displays a ranked arrangement of the products to the user. The user is able to directly adjust the weights for certain aspects to update the rankings, as well as compare selected products.

In one embodiment of the invention, a system for generating an interface for product browsing and comparison comprises an extraction unit which analyzes raw product information data for a plurality of products, extracts at least one aspect and at least one use relating to the plurality of products; a storage unit which stores the at least one aspect and at least one use, and which stores links between the at least one use and at least one aspect relevant to that use; and a user interface unit which receives a user input selecting at least one use and displays an arrangement of at least one of the plurality of products arranged based on a ranking of the products derived from at least the aspects linked to the at least one selected use.

The ranking of the products may be derived from weights of the aspects linked to the at least one selected use.

A user may directly select the weights for one or more aspects.

The at least one aspect may include a product feature, a product attribute or a product specification.

The raw product information data may include user reviews.

The extraction unit may extracts at least one reliable product feature from the user reviews using pattern-based text analysis.

The extraction unit may further extract the at least one reliable product feature from the user reviews using statistical classification methods.

The extraction unit may group similar product features by clustering noun sequences in the user reviews and filtering the clusters to remove clusters without at least one good product feature.

The at least one use may be extracted by filtering the output of pattern-based text analysis performed on the user-reviews to remove known non-uses, the non-uses comprised of at least one of product features, numbers and stopwords.

The extraction unit may further extract opinions relating to the features from the user reviews and displays at least one opinion relating to a good product feature.

In another embodiment of the invention, a method for generating an interface for product browsing and comparison comprises analyzing raw product information data for a plurality of products to extract at least one aspect and at least one use relating to the plurality of products; linking the at least one use with at least one aspect relevant to that use; storing the at least one aspect, the at least one use and the links between the at least one use and at least one aspect in a storage unit; receiving a user input selecting at least one use; and displaying an arrangement of at least one of the plurality of products arranged based on a ranking of the products derived from at least the aspects linked to the at least one selected use.

The ranking of the products may be derived from weights of the aspects linked to the at least one selected use.

The user may directly select the weights for one or more aspects.

The at least one aspect includes a product feature, a product attribute or a product specification.

The raw product information data may include user reviews.

The method may further comprise extracting at least one reliable product feature from the user reviews using pattern-based text analysis.

The method may further comprise extracting the at least one reliable product feature from the user reviews using statistical classification methods.

The method may further comprise grouping similar product features by clustering noun sequences in the user reviews and filtering the clusters to remove clusters without at least one good product feature.

The method may further comprise extracting the at least one use by filtering the output of pattern-based text analysis performed on the user reviews to remove known non-uses, the non-uses comprised of at least one of product features, numbers and stopwords.

The method may further comprise extracting opinions relating to the features from the user reviews and displaying at least one opinion relating to a good product feature.

In another embodiment of the invention, a computer program product for generating an interface for product browsing and comparison may be embodied on a computer-readable medium, and when executed by a computer, performs the method comprising analyzing raw product information data for a plurality of products to extract at least one aspect and at least one use relating to the plurality of products; linking the at least one use with at least one aspect relevant to that use; storing the at least one aspect, the at least one use and the links between the at least one use and at least one aspect in a storage unit; receiving a user input selecting at least one use; and displaying an arrangement of at least one of the plurality of products arranged based on a ranking of the products derived from at least the aspects linked to the at least one selected use.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 is a block diagram of a system and method for analyzing raw product information data and generating a user interface, including a pre-processing unit, a database, and a real-time user interface, according to one embodiment of the invention;

FIG. 2 illustrates a flow chart of a method of clustering and filtering frequent noun sequences to group product features, according to one embodiment of the invention;

FIG. 3 illustrates a method of extracting opinions about product features using a beta-binomial model, according to one embodiment of the invention;

FIG. 4 is a flow chart illustrating a method of selecting summary sentences from user reviews, according to one embodiment of the invention

FIG. 5 is a flow chart for identifying uses of a product, according to one embodiment of the invention;

FIG. 6 is an illustration of a graphical user interface (GUI) where users are prompted to answer questions relating to uses in order to identify relevant products, according to one embodiment of the invention;

FIG. 7 is an illustration of the GUI with a list of relevant products and corresponding aspects which can be manipulated by the user, according to one embodiment of the invention;

FIG. 8 is an illustration of the GUI showing top-ranked products, and detailed product information for a selected product, including specifications, uses and sample reviews, according to one embodiment of the invention;

FIGS. 9A-9F are illustrations of weight interactors which may be used to manipulate aspect weights. The interactor types include linear, dichotomous, continuous increasing, discrete increasing, continuous categories, and discrete categories, according to one embodiment of the invention;

FIG. 10 is an illustration of a GUI showing a comparison interface that uses parallel coordinates for illustrating product aspect values, according to one embodiment of the invention;

FIG. 11 is a flow chart illustrating a method of using the use-based user interface, according to one embodiment of the invention; and

FIG. 12 is a block diagram of a computer system upon which the system may be implemented.

### DETAILED DESCRIPTION

In the following detailed description, reference will be made to the accompanying drawings. The aforementioned accompanying drawings show by way of illustration, and not by way of limitation, specific embodiments and implementations consistent with principles of the present invention.

Systems and methods described herein provide use-based product searching by analyzing product information to provide a customizable user interface focused on high-level product information tailored to a users needs. All types of product information, from specifications, attributes and user reviews, are mined in order to determine product aspects and uses relevant to the user. The specifications, attributes, and product features are referred to collectively as “aspects,” and “uses” generally refer to what the user is doing with the product, or to the types of activities the user is engaged in when using the product. The user is provided with a graphical user interface (GUI) with which to select the uses for which the user plans to use the product, as well as areas to adjust the weight, or importance, of aspects related to those uses. The aspects may also be linked to particular uses and provided with implied weights, such that the user only needs to select uses in order to determine the aspects relevant to that use and the importance of those aspects to that use. The GUI then ranks the products based on the information from the user and displays relevant information on the products to the user. The user is able to adjust the weights for certain aspects to update the rankings, as well as compare selected products.

The system and interface described herein is use centric. With this approach, users initially answer questions about the types of situations in which they expect to use the product. The GUI displays the types of products that match their needs and exposes high-level product aspects related to the kinds of uses in which they have expressed an interest. As users explore the interface, they can reveal how those high-level aspects are linked to actual product features. This approach represents an inversion of typical product search, putting an emphasis on high-level user goals rather than low-level product details. To extract the high-level aspects used by the system from raw product information data such as user reviews and product specifications, semi-automatic methods may be used. These methods identify and group product features; mine and summarize opinions about those features from product reviews, and identify product uses based on the identified features.

With the embodiments described herein, users are able to more efficiently find products that match their needs based on how they expect to use the product. The system pre-processes specification data, attribute data, and open-text (user review) data to extract a set of product aspects, candidate uses for each product. This extracted data is stored in a database accessible by the graphical user interface (GUI) application. The GUI guides the user through a series of questions designed to set weights for aspects; the weights are then used to rank products. After this initial step, the system allows users to access product details, compare products, or alter weights directly. The combination of straightforward, high-level questions that weight aspects indirectly, in combination with the ability to give users more fine-grained, direct control over weighting means that the GUI can potentially be used both in situations requiring minimal user effort and technical knowledge (e.g., at a kiosk at the front of a store) as well as more typical scenarios (e.g., web browser).

The GUI blends a variety of product data types together with the goal of creating a product search experience focused on everyday use of a product rather than one focused exclusively on the technical specifications of the product. In order to create this experience, product features are extracted from user opinions (reviews) and tied together with higher level uses. Another goal of the user interface is to blend descriptive levels of product use using high level features (whether a camera is used for hiking or weddings) with low level features and specifications (price, resolution, etc.). Thus, when technical features are identified, they are contextualized by reported uses by actual users.

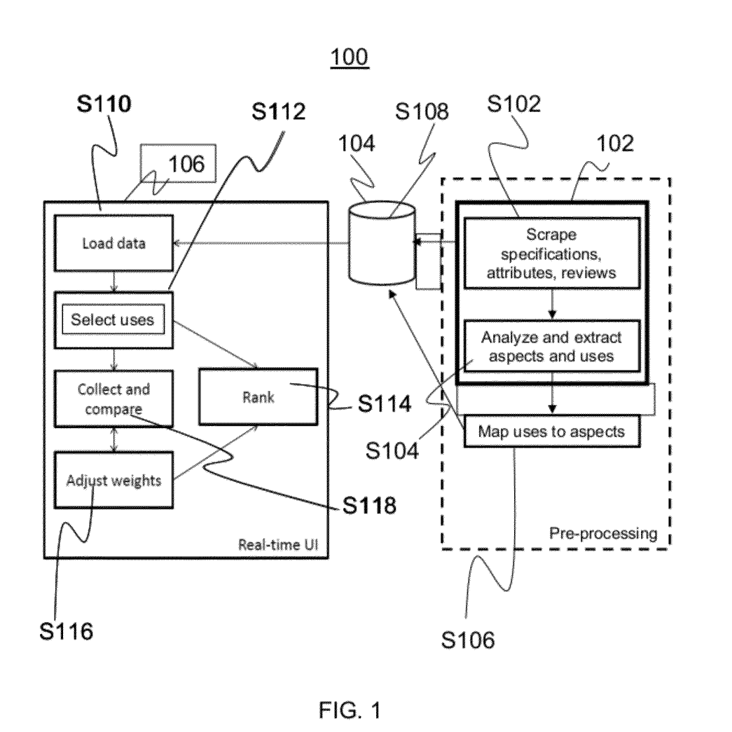

The systems and methods described herein combine data extraction processes with an interface that can rank products interactively according to weights specified both indirectly (by inferring weights from high-level uses) and directly (by interactors in the interface). In one embodiment illustrated in FIG. 1, the system 100 includes three distinct components: an extraction unit 102 which carries out most of the pre-processing steps, a database 104 to store raw and extracted data, and a real-time user interface unit 106. The pre-processing steps store all data to the database 104, which is then accessible by the user interface unit 106 to generate the graphical user interface that is displayed to a user. Although not illustrated here, the user interface unit 106 would be connected with a device which the user would interact with, including a display and input device or a touch screen device.

In the corresponding method of generating use-based product information also illustrated in FIG. 1, the extraction unit first mines specifications, attributes and user reviews to capture raw product information data (S102). The raw product information data is then analyzed to extract aspects and uses (S104). The aspects are then mapped to corresponding uses (S106), usually by a manual or semi-automatic process separate from the extraction unit 102, as will be described further below. The extracted data is then stored in the database for accessing by the user interface (S108). The user interface then loads the data and provides a weight for each of the aspects based on the relevance of each aspect to each use (S110), after which uses may be selected (S112) by the system or the user. The products are then ranked (S114) based on the weights of the aspects corresponding to the selected use, and the ranked products are presented to the user in an arrangement on a display. The user may additionally directly manipulate weights of the various aspects and alter the selected uses (S116) to see updated lists of relevant products, and may further collect and compare relevant products (S118).

The interface unit 106 makes use of several different types of raw product information data, described in a non-limiting embodiment herein with regard to a digital camera:

1) Specifications: Standard product specifications, such as maximum zoom level, maximum resolution, and weight.

2) Features of products derived from reviews. Features are derived from publicly-available user-generated text reviews, which go beyond standard specifications to describe, for example, whether a camera is durable in day-to-day use, or provide extra information about a well known specification (e.g., whether a built-in face detector works or is only a distraction). In one embodiment described further below, the features have been grouped to capture variations in expression. The features also provide for mining the opinions of each feature, as will also be described further below.

3) Attributes of products specifically rated by users in reviews. Attributes are usually derived from free text, but differ from features in that users explicitly select a rating for each attribute, whereas feature ratings must be derived implicitly from contextual text (adjectives, etc.).

4) Uses are derived from reviews, where uses may include: (1) the types of activities people are engaged in when using the product (e.g., for cameras, what the user is doing when taking a photo); (2) how the user applies the product in that use (e.g., what they take photos of); (3) what activities the product is used for (e.g., what they do with the photo after taking it). For many products, (2) can be derived from specific examples. For the example of a digital camera, a user can indicate the types of photos they take by selecting a set of examples prompted by the user interface. Similarly, for office software, the user can select the types of files they want to produce. The uses may be linked with aspects to help a user determine what aspects are relevant to a particular use. A use may be associated with one or more aspects, including the specifications, features, and attributes (e.g., a use “hiking” might be associated with aspects including specifications such as “size” and “weight”, a feature such as “durability”, and an attribute such as “construction quality”).

### I. Data Extraction and Analysis

The data analysis used to extract the aspects and uses from raw product information data in product reviews, specifications and attributes is discussed herein. In one embodiment, the raw product information data may be obtained from publicly available review data on Internet websites, such as Amazon® (www.amazon.com). To obtain the review data from a website such as Amazon®, one method is to first download Amazon's Product Advertising API (Application Programming Interface), which is structured XML (extensible markup language). In a further method, the web pages of the site may be scraped using a customized web scraping software program to extract information. Web scraping can be applied to any website, but may need to be customized for each website that is to be scraped.

### Reliable Product Feature Extraction

For purposes of this disclosure, product “features” are parts and properties of a product that are explicitly mentioned in user reviews. In one embodiment, a high-precision, web-scale pattern-based information extraction technique is used to identify candidate product features such as that developed by Yates and Etzioni (A. Yates and O. Etzioni. 2007. Unsupervised Resolution of Objects and Relations on the Web. Proceedings of NAACL-HLT, pp: 121-130) and Etzioni et. al. (O. Etzioni, et al. 2005. Unsupervised Named-Entity Extraction From the Web: an Experimental Study. Artificial Intelligence 165(1), pp: 91-134). These methods may be applied to the extraction of product features as disclosed by Popescu and Etzioni (A. M. Popescu and O. Etzioni. 2005. Extracting Product Features and Opinions from Reviews. Proceedings of HLT/EMNLP, p. 346). These steps include using patterns to identify noun phrase (NP) candidate features. This is followed by applying a statistical technique, such as machine learning, to identify reliable product features.

For purposes of this disclosure, the process for extracting product features may include the steps described below. Additional natural language processing steps (5 and 6) are introduced to compensate for the smaller scale of data that may often be available for a product review:

1) Manually construct a small list of positive and negative examples of product features. e.g. lens, zoom, image quality would be among the positive examples for cameras, and daughter, Christmas, vacation, would be among the negative examples.

2) Extract patterns of words 4 to the left and 4 to the right of every seed feature occurrence in the review data. For example, for the seed feature lens in the sentence, The lens scratches easily., the following patterns would be extracted, where NP stands for noun phrase:
The NP scratches easily.
The NP
NP scratches easily.
NP scratches

3) Compute the estimated precision of the extracted patterns. The greater the ratio of positive to negative examples with which a pattern occurs, the higher its precision.

4) Scan through all the reviews and extract sequences that match the top 500 highest-precision patterns, and extract the parts corresponding to noun sequences as candidate features. The noun sequences are identified using a part-of-speech tagger, such as the Stanford Log-linear Part-Of-Speech Tagger (nlp.stanford.edu/software/tagger.shtml)

5) Use a Support Vector Machine (SVM) with web-based Point-wise Mutual Information (PMI) features to select reliable features (P. D. Tumey. 2002. Thumbs Up or Thumbs Down? Semantic Orientation Applied to Unsupervised Classification of Reviews. Proceedings of the 40th Annual Meeting of Association for Computational Linguistics. pp. 417-424). For each candidate feature, the components of the feature vector passed to the SVM are web-based PMI statistics with the discriminators “<product> features <candidate>” and “<product> has <candidate>.” For example, “camera has lens,” or “camera features optical zoom.”

### Term Similarity and Grouping

For computing noun-phrase similarity, a simplified version of Lin's approach is used (D. Lin. 1998. Automatic retrieval and clustering of similar words, Proceedings of the 17th International Conference on Computational Linguistics, pp. 768-774), which is computationally simpler and targeted to this type of activity. Since the system is concerned with phrases, for which the number of unique types can be many more than the number of unique words, being able to compute the similarity of the phrases without needing to consider all other words and possibly phrases in the corpus is important.

Several methods for post-processing distributionally similar groups of words are possible. Lin et al. proposed two methods: (1) computing the ratio of the number of hits to a query for a pair of words being “NEAR” to the number of times a pair of words occur in two phrases (from X to Y; either X or Y); and (2) using bilingual dictionaries (D. Lin, S. Zhao, L. Qin, and M. Zhou. 2003. Identifying synonyms among distributionally similar words. vol. 18, pp. 1492-1493). The use of bilingual corpora is also possible, as discussed in L. van der Plas and J. Tiedemann. 2006. Finding synonyms using automatic word alignment and measures of distributional similarity. Proc. COLING/ACL 2006. pp. 866-873. However, in the embodiments herein, computed reliable features and/or pre-defined attributes (such as those used on Amazon.com®) are utilized. Amazon attributes are product features that Amazon displays at the top of a Customer Reviews page, which invites visitors to provide a rating from 1 to 5 for each listed feature. There are usually less than 10 attributes listed. The set of displayed attributes varies from product to product, e.g., varies for each camera. Examples of attributes include “Ease of use”, “Learning curve”, “Image stabilization”, “Hardware quality”, and “Picture quality.” Rather than inferring a rating from unstructured text, an average rating for the attribute is directly extracted from the data.

### Grouping Product Features

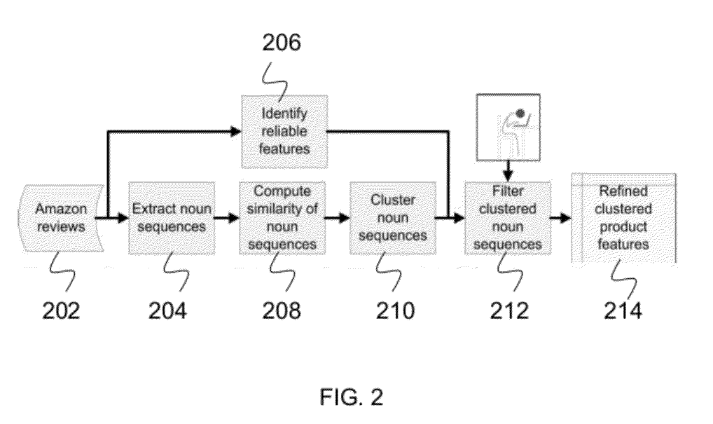

Once a base set of features are identified, clustering may be used to group product features, including reliable product features, into synonymous groups that capture various ways that reviewers may refer to the same feature. Although the reliable features could be directly clustered, better results may be achieved by clustering frequent noun sequences (i.e., one or more adjacent nouns) and using the reliable features to “filter” the noun sequences in the clusters, using the steps outlined in FIG. 2. First, user review data is obtained and loaded into the extraction unit (S202), such as the review data from user reviews on a known website such as Amazon.com®. In S204, the noun sequences are extracted from sentences tagged with part-of-speech. The process of identifying reliable features S206, also described above, is carried out during the process of clustering the noun sequences. The similarity between all pairs of frequent noun sequences is computed in S208 based on how similar their set of observed adjective modifiers are. This approach is a simplification of the method introduced by Lin (cited above), which considers all terms in a set of documents and all dependency relations to compute the similarity between two words. In this case, the similarity of noun sequences is computed rather than words, and only adjective modifier relations rather than all dependency relations are used, reducing the number of relations that need to be managed. In particular, only two types of adjective-noun sequence relations were considered: direct modifiers, as in the phrase “brilliant sunset”, and adjectives that modify through a verb, as in the sentence “The block was yellow.”

For each sentence in the review data where a noun sequence occurs, the corresponding adjective modifiers and relation between the adjective and noun sequence are extracted from the parse tree. If it is assumed that a phrase and an adjective are conditionally independent given a modifier relation, then the probability of a noun phrase, N, an adjective, A, and a modifier relation, R, between the noun sequence and adjective co-occurring can be written as:

P(R)P(N|R)P(A|R) (1)

and the mutual information between N and A related by R, l(N, R, A), is computed as:

$$I ( N , R , A ) = log ( \frac{P ( N , R , A )}{( P ( R ) P ( N \vert R ) P ( A \vert R )} ) , \qquad ( 2 )$$

or
in terms of counts:

$$I ( N , R , A ) = log ( \frac{‖ n , r , a ‖ \times ‖ * , r , * ‖}{‖ n , r , * ‖ \times ‖ * , r , a ‖} ) \qquad ( 3 )$$

Given that r is a relation and a is an adjective, T(w) is defined to be the set of pairs (r, a) where l(n, r, a) is positive. The similarity between two noun sequences, n1 and n2, is then computed as:

$$sim = \frac{{\sum }_{( r , a ) ∈ T ( {w}_{i} ) ⋂ T ( {w}_{2} )} ( I ( {n}_{1} , r , a ) + I ( {n}_{2} , r , a ) )}{{\sum }_{( r , a ) ∈ T ( {w}_{i} )} I ( {n}_{1} , r , a ) + {\sum }_{( r , a ) ∈ T ( {w}_{2} )} I ( {n}_{2} , r , a )} \qquad ( 4 )$$

The computed similarity between all frequent pairs of noun sequences (in our case with over 1 million sentences, a threshold of 50 may be set) is used for clustering the phrases in S210. A variety of clustering algorithms can be used. In this example, a complete-linkage agglomerative clustering is used to keep the phrases compact, and then split the hierarchical tree into clusters using a manually set threshold. In the “refine” step S214 in FIG. 2, the clusters are first filtered S212 using the reliable features identified in S206 to keep only noun sequences that have been identified as reliable.

An example of the resulting list of top automatically-produced clusters is shown below. Note that the majority of the largest clusters are related to the review topic, ‘cameras’ in this case, but there are additional clusters, such as ‘bang, deal, value, job’. These can be removed by keeping only clusters that contain at least one of the rated Amazon attributes. Alternative methods of filtering are possible by filtering using any “good product feature,” such as filtering by Amazon attributes only or by web-based PMI. Reliable features (described above) are another set of the “good product features” that may be used for filtering. The top-scoring, automatically-produced camera feature clusters using the method are:
camera, body;
photos, pics, pictures and shots;
battery life, photo quality, quality, picture quality, image quality
zooms, zoom
screen, lcd, view screen, lcd screen, lcd display, display
lens, lenses
image shot, picture
bang, deal, value, job
settings, setting
aa batteries, batteries

### Opinion Mining

Opinion mining is used to estimate the polarity of the automatically identified product features. Opinion mining can refer to activities of various levels of granularity. In one embodiment, the system is operated on the finer scale of features within sentences, where the approach is to identify all the “opinion words” that apply to the feature, and aggregate their individual polarities to give a score. The opinion scores are used in combination with the feature weights and scores/ratings of other aspects to score a product, and the products are ranked based upon the scores. Uses are independent, and extracted as described further below. Linking of the uses and aspects may be performed manually. However, for reviews where a use is mentioned, the aspect values from those reviews can be presented, and an activity for the reviewed product/camera created with that use and those aspect values.

Aggregating information from individual opinions units into a single score is a common activity in sentiment analysis. However, known methods do not smooth their estimates because they either assume or ensure that the smaller units are plentiful enough that aggregating them will give a reliable measure of the true sentiment. In the embodiments herein, all products mentioned, such as all types of cameras, may be covered, and so some features of a product only have one or two adjectives expressing opinions about them. Existing sentiment analysis systems are unable to solve the problem of estimating opinion from a very small number of observations.

To extract opinions about product features, review sentences are first classified as either objective or subjective, then identify and classify opinion words, and finally aggregate the opinion-word polarities to get an opinion score. To identify subjective sentences, a publicly available labeled corpus is used to train an n-gram classifier. Opinion words may be defined, in one embodiment, to be adjectives that modify product features. To classify opinion words as positive or negative, Turney's web-PMI method may be used (P. D. Turney. 2002. Thumbs Up or Thumbs Down? Semantic Orientation Applied to Unsupervised Classification of Reviews. Proceedings of the 40th Annual Meeting of Association for Computational Linguistics. pp. 417-424).

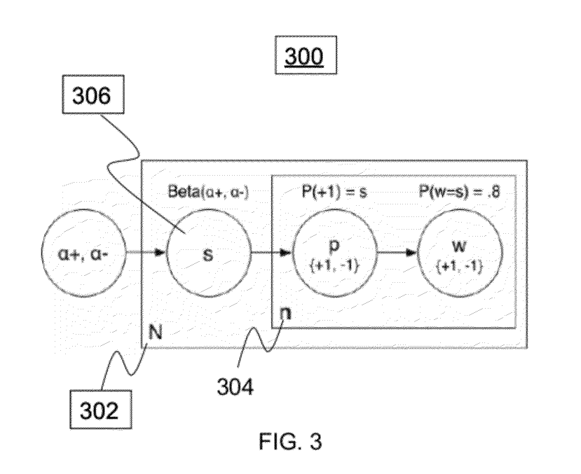

FIG. 3 illustrates a beta-binomial model 300 that may be used for opinion smoothing. N 302 is the number of product features, and n 304 is the number of adjectives observed for each product feature.

The beta-binomial model is used to calculate smoothed opinion scores s 306 for a product feature from scores of its n observed opinion words {w1, . . . , wn} where wi E{+1, −1}. A generative model may be used, where s is generated by a beta distribution with parameters a+ and a_. In turn, s determines the probability of observing a positive-polarity adjective i.e.:

P(p=+1)=s, P(p=−1)=1−s. (5)

Since it is not certain that the SVM classifier is reliable, another layer is added to the model, and it is assumed that the classified polarities are generated by a binomial distribution with P(classifier is correct)=0.8.

Finally, a₊=a_{—}=1 is set, meaning that positive and negative adjectives are a-priori equally likely. This model was fit using Gibbs sampling with the polarities of the adjectives observed for each product feature, and s 306 is used as the final sentiment score. In essence, this means that when there are only a small number of adjectives available, extreme estimates are not given of the quality of the product feature.

Pang and Lee noted that the accuracy of opinion estimation improves when sentences that are subjective are first identified and opinion estimation is performed only on subjective sentences (B. Pang and L. Lee. 2008. Opinion Mining and Sentiment Analysis. Foundations and Trends in Information Retrieval, vol. 2, pp: 1-135). In one embodiment, to identify subjective sentences, the subjectivity labeled sentences in Pang and Lee's Movie Database may be used to train an n-gram classifier. The trained classifier is then used to classify sentences from publicly-available website reviews for subjectivity. To extract and classify opinions from subjective sentences, opinion words are taken to be adjectives that modify product features. For each subjective sentence in the review data where a product feature occurs, any adjectives that are related to the feature by amod (adjective modifier), advmod (adverb), or nsubj (through a verb) are extracted. If a neg (negation) modifies the adjective, the adjective is marked as negated.

For each adjective, a feature vector is computed consisting of web-PMI with the words excellent, fantastic, terrible, and awful. Counts for computing PMI are obtained using an API to query Yahoo and extract the estimated number of search results. An SVM is trained to classify these feature vectors using Opinion Finders subjectivity lexicon, available at www.cs.pitt.edu/mpqa/. The resulting accuracies are provided in Table 1, below.

TABLE 1
Opinion Polarity Classification Accuracy

| polarity | precision | recall | F₁ |
|---|---|---|---|
| positive | 0.84 | 0.69 | 0.76 |
| negative | 0.75 | 0.81 | 0.78 |

### Summary Sentence Selection

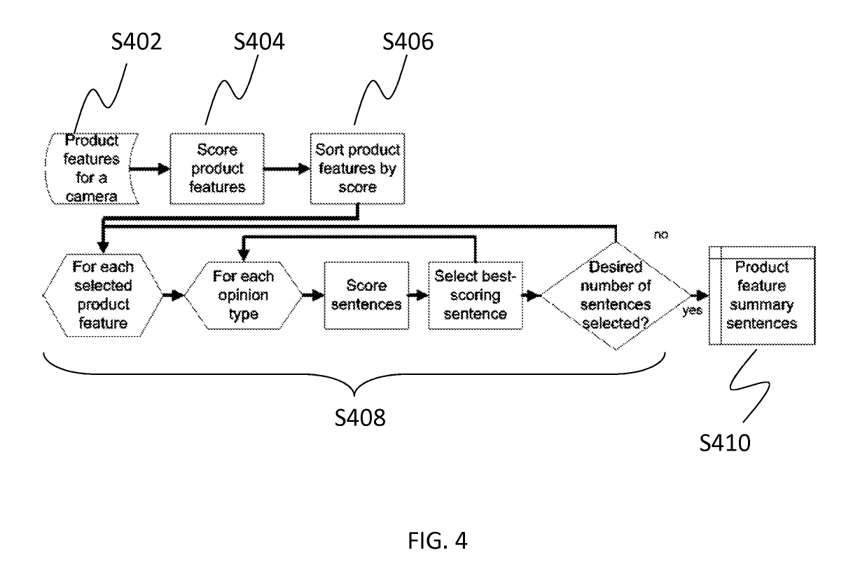

In one embodiment, to give a user feel for the opinions expressed about a camera, a small number of sentences may be automatically selected to represent opinions about a selected sample of camera features. In this method, illustrated in FIG. 4, for a given product such as a camera, the set of identified clusters of reliable product features mentioned in reviews of the camera are received (S402) and subsequently scored (S404). For a given camera, the product features are scored based on: 1) the number of unique sentences expressing an opinion about the product feature and 2) the PMI score of the feature phrase and the term ‘camera.’ A better score is assigned to product features with larger PMI scores and that occur in more sentences. Although a number of score combination methods can be used, we simply multiply the two scores. The product features are then sorted by score (S406). Then for each ordered feature in turn, sentences in the camera reviews containing the feature are scored and ordered and up to the best N representatives (two in our case) are selected, until a preset maximum number of sentences are identified or a preset number of features summarized (S408). Additionally, positive and negative adjectives describing each selected feature are collected for presentation.

Sentences are selected to represent some or all of the product feature clusters. A maximum number of desired summary sentences can be specified, or the maximum number determined automatically, e.g., requiring sentence scores to be above a minimum value. For a given product feature, a score is computed for each sentence associated with the product feature of a given polarity. Only sentences where the product feature is contained in the pattern <adj> <noun sequence> are considered. The score favors frequently mentioned product features, frequently mentioned adjective and noun-phrase pairs, and high PMI between the adjective(s) and noun-phrase.

### Extracting Product Uses

In one embodiment, “product uses” may be defined again in terms of a camera to be terms that describe: 1) what people take photos of 2) what people are doing when they take photos and 3) what they do with photos. These three types of product use are often inter-related. For example, ‘birthday party,’ ‘wedding,’ ‘running of the bulls,’ ‘ballroom dancing,’ and ‘Garden of the Gods in Colorado Springs’ are all things people are taking photos of, but they are also indicate what the person is doing. For this reason, the different types of uses are not automatically separated into mutually exclusive sets.

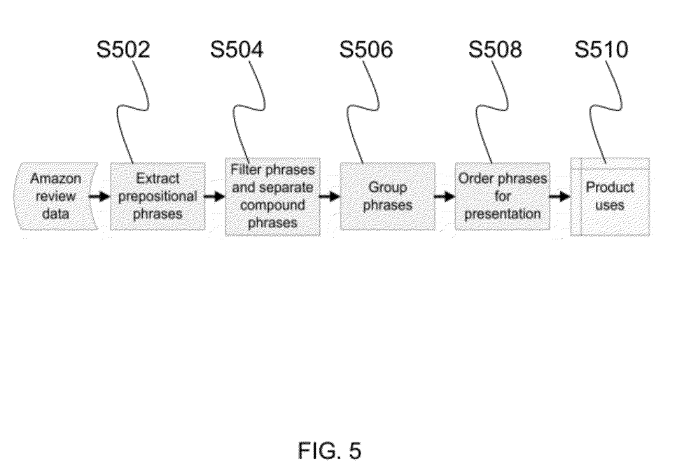

A flowchart illustrating a method for identifying camera uses according to one embodiment is shown in FIG. 5. Camera uses are identified by first searching for patterns representing common expressions that may be used to indicate a use. For this, we use the noun sequences associated with the noun “picture,” which includes {picture, pictures, photo, photos, pic, pics} in a pattern of the form <picture term> <prepositional phrase>. These prepositional phrases are first extracted from the review data (S502). The matching phrases are filtered to remove reliable product features, such as ‘lens’ and ‘shutter’, and phrases with numerical values (S504). If a phrase contains a compound phrase—i.e., more than one noun sequence, such as ‘pictures of people and pets’—the noun sequences are extracted separately (S504). Noun sequences that are in a stoplist, such as ‘anything’, may also be removed from consideration. The remaining phrases are then grouped (S506). For grouping, all phrases with the same last noun in a noun sequence are grouped. For example, ‘zoo’, ‘Washington Zoo’, and ‘San Diego Zoo’ are all grouped under ‘zoo’. The groups are then sorted by frequency for presentation (S508). A person can then easily examine and filter the list to identify true camera uses (S510).

The top 25 automatically-identified uses, along with the three most frequent phrases associated with each use, are shown in Table 2, below. A sample of automatically-identified “what people are doing when taking a photo” with frequent phrases is shown in Table 3.

TABLE 2
Top 25 automatically identified “camera uses” and the three most
frequent phrases associated with each use.

| | | | |
|---|---|---|---|
| light | in low light | in bright light | in good light |
| people | of people | with people | of two people |
| conditions | in low light | inₐₗₗ conditions | under most |
| | conditions | | conditions |
| time | at a time | at one time | at the same time |
| kids | of the kids | of kids | of kids and pets |
| family | of family | of the family | of family and |
| | | | friends |
| friends | of friends | of family and | with friends |
| | | friends | |
| computer | on the computer | on computer | on a computer |
| price | for the price | at a great price | at a reasonable price |
| flowers | of flowers | of the flowers | of flowers and birds |
| day | during the day | on a sunny day | from day |
| dark | in the dark | in dark | in complete dark |
| color | with great color | with good color | in color |
| cameras | with both cameras | from both cameras | with other cameras |
| tv | on TV | on the TV | on a TV |
| set | on a set | on one set | with one set |
| succession | in rapid | in quick succession | in succession |
| | succession | | |
| row | in a row | | |
| children | of children | of small children | of the children |
| moon | of the moon | of the full moon | of the Moon |
| items | of items | of small items | of the same items |
| birds | of birds | of birds and wildlife | of flowers and birds |
| room | in a room | in a dark room | in a darker room |
| water | under water | in the water | under the water |

TABLE 3
Examples of automatically identified uses—“what people are doing while
taking a photo” and the two most frequent phrases.

| | | |
|---|---|---|
| holidays | the holidays | the EID Holidays |
| snorkeling | snorkeling | snorkeling and scuba diving |
| hiking | hiking | camping and hiking |
| skiing | skiing | |
| diving | diving | snorkeling and scuba diving |
| game | a basketball game | a double header or a full football |
| | | game |
| kayaking | kayaking | kayaking or horseback riding |
| | | or hiking |
| dinner | dinner | a special occasion dinner |
| distances | all different lights and | |
| | distances | |
| meetings | public meetings | |
| snowfall | a heavy snowfall | |
| header | a double header or | |
| | a full football game | |
| sightseeing | sightseeing | |
| camping | camping and hiking | |
| stingrays | chasing fish or stingrays | |
| riding | kayaking or horseback | |
| | riding or hiking | |
| christmas | christmas | |
| fish | chasing fish or stingrays | |

Linking Uses with Aspects

The final step in data extraction is to link the aspects to each use. In one embodiment, these links are constructed manually. In another embodiment, a semi-automated approach would be to use simple correlation—for each use, select aspects that appear most frequently in cameras that support the use.

### Ranking

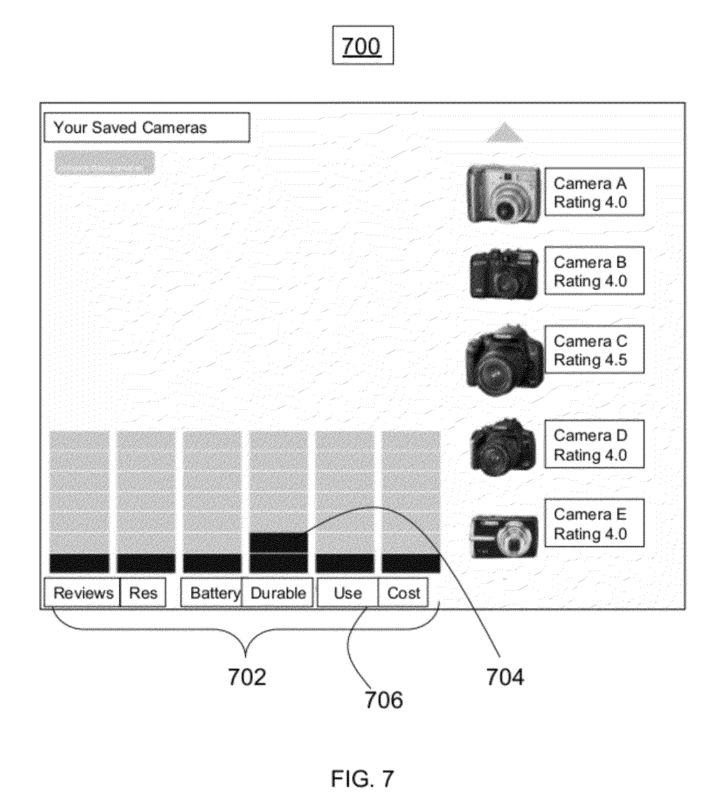

Once aspects and uses have been extracted and linked, products can be ordered for display on the user interface. In one embodiment, a ranking algorithm may be used that orders products according to user-specified weights. A simple scale selector graphic 702, as illustrated in the GUI screen 700 of FIG. 7 shows the current weight, or importance of a specification, feature, or attribute. To calculate the ranking, each weight is then applied to a normalized value for the specification, feature, or attribute for each camera.

Another approach is to infer weights from user activity and interest. While there are many ways to infer such weights, one option is via reverted indexing, as described in J. Pickens, M. Cooper, and G. Golovchinsky; Reverted Indexing for Feedback and Expansion. Proceedings of ACM CIKM. Using this approach, aspects and uses are associated with the set of products that they retrieve. Each set of associations is then indexed, as per traditional document indexing. At runtime, an arbitrary (user-driven) set of products can then be selected and the most relevant aspects and uses are retrieved using well-established information retrieval ranking algorithms. The relevance score assigned to each specification or attribute is then used as a weight on that attribute, to again retrieve the most relevant, related products.

### II. Interface

### Detail Views

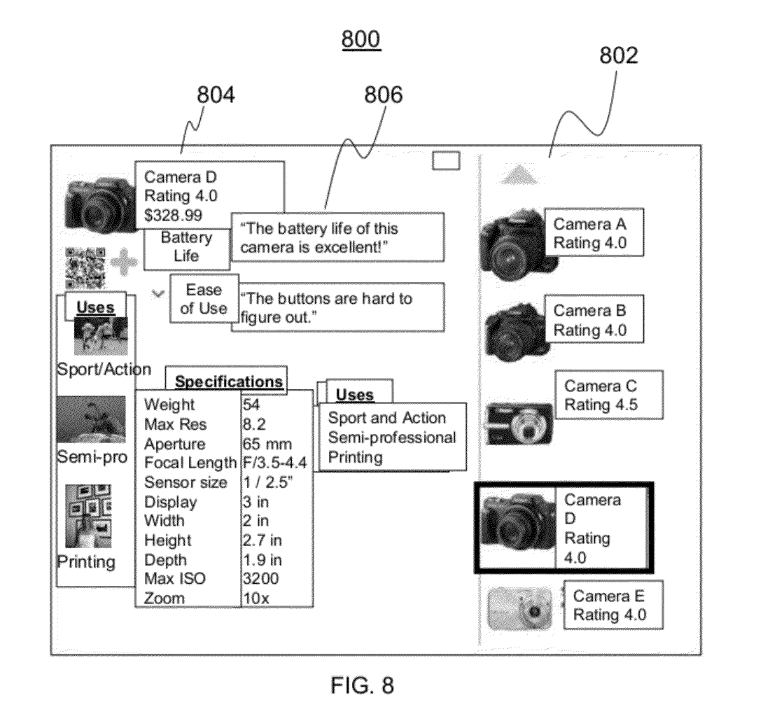

Making a product decision is never as simple as setting a range of values and choosing from a list. Therefore, the graphical user interface (GUI) described herein allows the user to explore the product and its aspects in more detail. To facilitate this, one GUI screen 800 in FIG. 8 includes a view of each camera 802 showing not only all of its specifications 804 but also highlights from reviews 806 about specific product aspects. These highlights 806 were automatically extracted (see the data analysis section above) and provide summaries of important issues from reviews. Importantly, these highlights 806 are linked to actual reviews themselves so that users can see the context of the reviewer's comments. In this way, the GUI provides a link from abstracted product aspects down to review details. To go back up the chain, users can click on widgets next to review highlights that let them directly manipulate the aspects to which that highlight is linked.

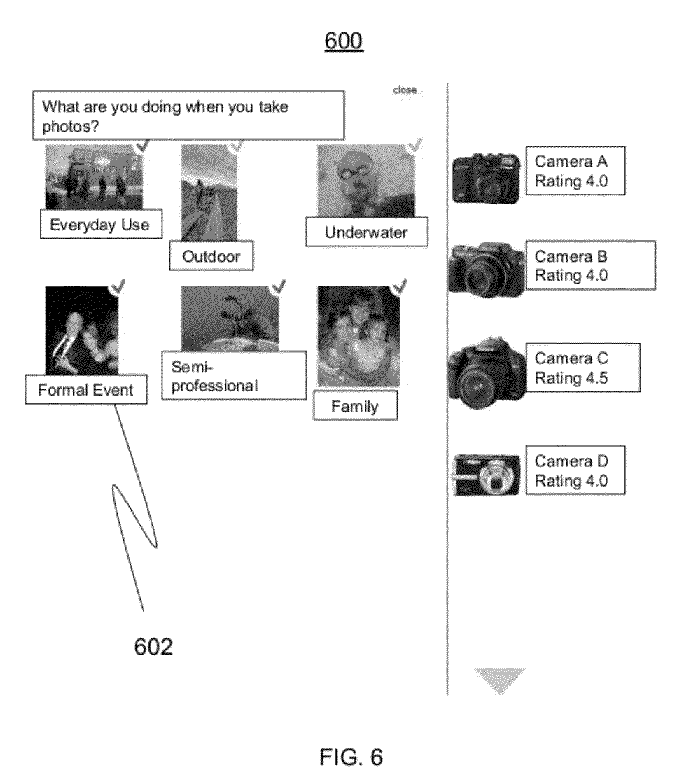

As mentioned above, the ranking system may depend on user-specified weights of camera specifications and features. The interface allows weights to be adjusted both indirectly and directly. In one embodiment illustrated in the GUI screen 600 in FIG. 6, users can specify weights indirectly by selecting the uses 602 they want to perform with the product. Uses may be organized manually into groups that address a more specific question. In one embodiment, uses may be organized into three groups: the uses the user is doing at the time of capture (e.g., hiking), what types of uses the user is taking pictures of (e.g., mountain scenery), and what the user intends to do with the photos (e.g., put them in a scrapbook).

Since the uses are mapped to the aspects, selecting uses implicitly adjusts weights. Users can also manipulate weights directly using the GUI screen 700 in FIG. 7, by selecting different levels 704 for each aspect 706. A user may provide a weight value of zero if a particular aspect is not important. The approach of manipulating weights of aspects is relatively unusual—most search interfaces involve selecting facets, or set ranges of target values. The focus on weights rather than facets is because weights do not require knowledge of technical detail (e.g., weights allow users to specify how much they care about camera resolution, rather than specifying resolution exactly, which would require users to have an understanding of the state of the art for that particular feature).

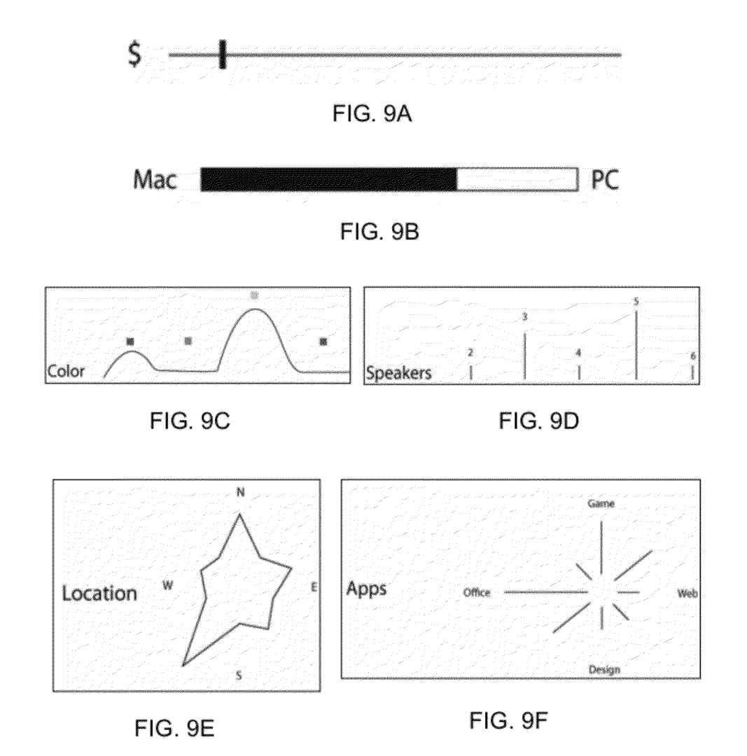

Various GUIs for specifying weights are available, as illustrated in FIGS. 9A-9F. The simplest interactor for specifying weights is a linear slider in FIG. 9A. In FIG. 9B, an exemplary dichotomous slider specifies a weight for a tradeoff value (such as Mac vs. PC in a laptop search interface). While only the simplest types of weight controls are represented in the current GUI (FIG. 7), a range of other types are possible, including:

1) Continuous, increasing (FIG. 9C): This interactor specifies weights for categories that are continuous (not binned) and increase. For example, color more-or-less increases linearly (in wavelength). Since this type of value is continuous, dragging any part of the line creates a fuzzy (rounded) edge. The area under the curve is constant.

2) Discrete, increasing (FIG. 9D): This interactor specifies weights for categories that are binned and increase. For example, this could be used to specify different weights for the number of speakers in a car's audio system. This interactor works much like a series of linear interactors except that the total length of all of the lines does not change.

3) Continuous, categories (FIG. 9E): This interactor is similar to a spider plot and specifies weights for categories that are continuous (not binned) but do not necessarily monotonically increase. For example, this could be used to specify areas of a city to include in an apartment search interface. The interactor's area is constant.

4) Discrete, categories (FIG. 9F): This interactor specifies weights for categories that are binned but do not necessarily monotonically increase. For example, this could be used to specify the different kinds of applications for which to maximize performance in a laptop search interface. The total length of all of the lines does not change.

### Comparison View

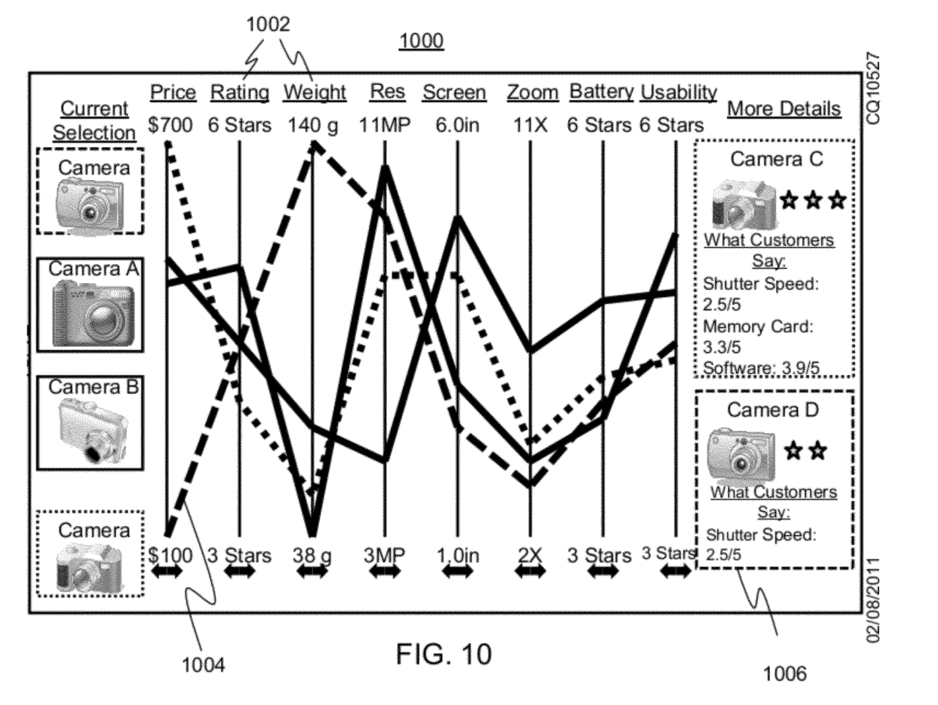

While adjusting weights produces an ordered list of products, the process of specifying weights is never static—users will adjust weights to explore how they affect the ranking. Along the way, they may encounter products they like but that may disappear from the top of the list in a later ranking. It is important that users be able to collect products along the way and be able to compare products in their collection. To support this need, a parallel coordinates interface 1000 is presented in FIG. 10 that integrates an overview, zoom and filter, and details-on-demand approach. Unlike a classic parallel coordinates display, there are only a few data points 1002, so users are allowed to click on each camera's line 1004 to see more details. A display box 1006 appears on the right, showing the rating, QR code, and opinion scores for product aspects

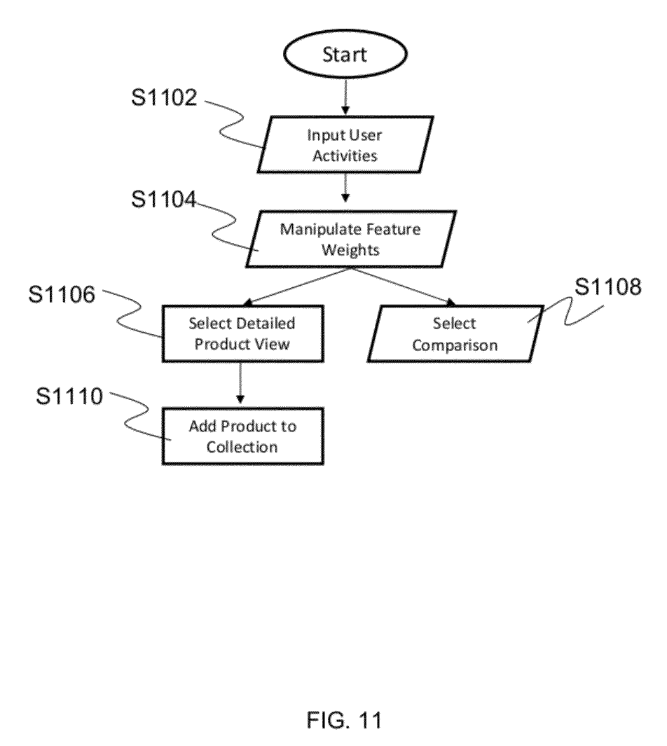

FIG. 11 illustrates a method of using the use-based user interface, according to one embodiment of the invention. The user first inputs information on intended uses (S1102), after which the GUI presents the user with a list of products to review. The user may then manipulate the weights for the various product aspects (S1104) in order to see different products based on the user's preferences relating to each aspect. The user may select a product (S1106) to see a detailed view of the product information, including existing user opinions, and the user may also request a comparison view (S1108) to see the parallel-coordinates interface discussed above. Finally, the user may add the selected product to a collection (S1110) for future comparison. The user can continue to interact with the system from any view by performing any operation available in the same or linked views, as shown in FIG. 11.

### III. Computer Embodiment

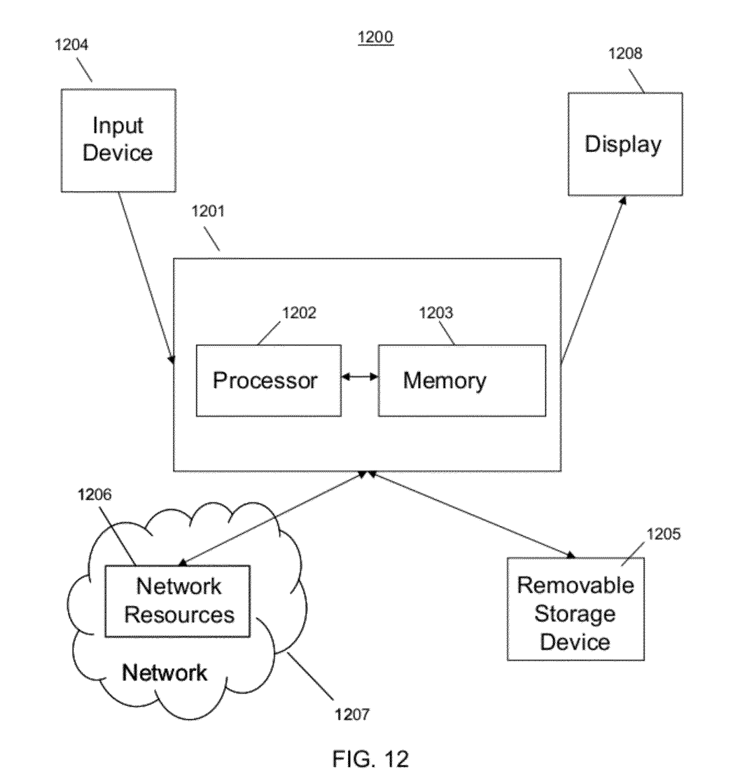

FIG. 12 is a block diagram that illustrates an embodiment of a computer/server system 1200 upon which an embodiment of the inventive methodology may be implemented. The system 1200 includes a computer/server platform 1201 including a processor 1202 and memory 1203 which operate to execute instructions, as known to one of skill in the art. The term “computer-readable storage medium” as used herein refers to any tangible medium, such as a disk or semiconductor memory, that participates in providing instructions to processor 1202 for execution. Additionally, the computer platform 1201 receives input from a plurality of input devices 1204, such as a keyboard, mouse, touch device or verbal command. The computer platform 1201 may additionally be connected to a removable storage device 1205, such as a portable hard drive, optical media (CD or DVD), disk media or any other tangible medium from which a computer can read executable code. The computer platform may further be connected to network resources 1206 which connect to the Internet or other components of a local public or private network. The network resources 1206 may provide instructions and data to the computer platform from a remote location on a network 1207. The connections to the network resources 1206 may be via wireless protocols, such as the 802.11 standards, Bluetooth® or cellular protocols, or via physical transmission media, such as cables or fiber optics. The network resources may include storage devices for storing data and executable instructions at a location separate from the computer platform 1201. The computer interacts with a display 1208 to output data and other information to a user, as well as to request additional instructions and input from the user. The display 1208 may therefore further act as an input device 1204 for interacting with a user.

The embodiments and implementations described above are presented in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

1. A system for generating an interface for product browsing and comparison, comprising:
a processor;
an extraction unit which analyzes raw product information data for a plurality of products, extracts at least one aspect and at least one use relating to the plurality of products, wherein the at least one aspect includes at least one of a product feature, a product attribute and a product specification, and wherein the at least one use includes at least one of an activity associated with the plurality of products and an application of the plurality of products;
a storage unit which stores the at least one aspect and at least one use, and which stores links between the at least one use and at least one aspect relevant to the at least one use, wherein the at least one aspect relevant to the at least one use is determined by analyzing which of the at least one aspect is related to the at least one use; and
a user interface unit which receives a user input selecting at least one use and displays an arrangement of at least one of the plurality of products arranged based on a ranking of the products derived from at least the aspects linked to the at least one selected use.

2. The system of claim 1, wherein the ranking of the products is derived from weights of the aspects linked to the at least one selected use.

3. The system of claim 2, wherein a user directly selects the weights for one or more aspects.

4. (canceled)

5. The system of claim 1, wherein the raw product information data includes user reviews.

6. The system of claim 5, wherein the extraction unit extracts at least one reliable product feature from the user reviews using pattern-based text analysis.

7. The system of claim 6, wherein the extraction unit further extracts the at least one reliable product feature from the user reviews using statistical classification methods.

8. The system of claim 5, wherein the extraction unit groups similar product features by clustering noun sequences in the user reviews and filtering the clusters to remove clusters without at least one good product feature.

9. The system of claim 5, wherein the at least one use is extracted by filtering the output of pattern-based text analysis performed on the user-reviews to remove known non-uses, the non-uses comprised of at least one of product features, numbers and stopwords.

10. The system of claim 5, wherein the extraction unit further extracts opinions relating to the features from the user reviews and displays at least one opinion relating to a good product feature.

11. A method for generating an interface for product browsing and comparison, comprising:
utilizing a processor to analyze raw product information data for a plurality of products to extract at least one aspect and at least one use relating to the plurality of products, wherein the at least one aspect includes at least one of a product feature, a product attribute and a product specification, and wherein the at least one use includes at least one of an activity associated with the plurality of products and an application of the plurality of products;
linking the at least one use with at least one aspect relevant to the at least one use, wherein the at least one aspect relevant to the at least one use is determined by analyzing which of the at least one aspect is related to the at least one use;
storing the at least one aspect, the at least one use and the links between the at least one use and at least one aspect in a storage unit;
receiving a user input selecting at least one use; and
displaying an arrangement of at least one of the plurality of products arranged based on a ranking of the products derived from at least the aspects linked to the at least one selected use.

12. The method of claim 11, wherein the ranking of the products is derived from weights of the aspects linked to the at least one selected use.

13. The method of claim 12, wherein the user directly selects the weights for one or more aspects.

14. (canceled)

15. The method of claim 11, wherein the raw product information data includes user reviews.

16. The method of claim 15, further comprising extracting at least one reliable product feature from the user reviews using pattern-based text analysis.

17. The method of claim 16, further comprising extracting the at least one reliable product feature from the user reviews using statistical classification methods.

18. The method of claim 16, further comprising grouping similar product features by clustering noun sequences in the user reviews and filtering the clusters to remove clusters without at least one good product feature.

19. The method of claim 15, further comprising extracting the at least one use by filtering the output of pattern-based text analysis performed on the user reviews to remove known non-uses, the non-uses comprised of at least one of product features, numbers and stopwords.

20. The method of claim 15, further comprising extracting opinions relating to the features from the user reviews and displaying at least one opinion relating to a good product feature.

21. A computer program product for generating an interface for product browsing and comparison, the computer program product embodied on a computer-readable storage medium and when executed by a computer, performs the method comprising:
analyzing raw product information data for a plurality of products to extract at least one aspect and at least one use relating to the plurality of products, wherein the at least one aspect includes at least one of a product feature, a product attribute and a product specification, and wherein the at least one use includes at least one of an activity associated with the plurality of products and an application of the plurality of products;
linking the at least one use with at least one aspect relevant to the at least one use, wherein the at least one aspect relevant to the at least one use is determined by analyzing which of the at least one aspect is related to the at least one use;
storing the at least one aspect, the at least one use and the links between the at least one use and at least one aspect in a storage unit;
receiving a user input selecting at least one use; and
displaying an arrangement of at least one of the plurality of products arranged based on a ranking of the products derived from at least the aspects linked to the at least one selected use.

22. The system of claim 5, wherein the at least one use is extracted from the user reviews,
wherein the raw product information data further includes product specification documents, and
wherein the at least one aspect is extracted from the product specification documents.

23. The method of claim 15, wherein the at least one use is extracted from the user reviews,
wherein the raw product information data further includes product specification documents, and
wherein the at least one aspect is extracted from the product specification documents.
